(19) United States
(12) Patent Application Publication
(10) Pub. No.: US 2022/0010789 A1
(43) Pub. Date: Jan. 13, 2022

(54) Electrically Powered and Electronically Controlled Diaphragm Ink Pump Apparatus and Method

(71) Applicant: Sun Automation, Inc., Glen Arm, MD (US)

(72) Inventors: Thad FULLEM, Felton, PA (US); Aaron Schlothauer, Parkville, MD (US)

(73) Assignee: Sun Automation, Inc., Glen Arm, MD (US)

(21) Appl. No.: 17/289,934

(22) PCT Filed: Sep. 25, 2019
(86) PCT No.: PCT/US19/52989

§ 371 Date: Apr. 29, 2021

Related U.S. Application Data
(60) Provisional application No. 62/736,377, filed on Sep. 25, 2018.

(51) Int. Cl. F04B 43/04; F04B 15/02; F04B 53/00; F04B 49/20

(52) U.S. Cl. CPC F04B 43/04; F04B 15/02; B41J 2/17596; F04B 49/20; F04B 53/006

(57) ABSTRACT

An electrically powered and electronically controlled diaphragm ink pump apparatus (e.g., 100, 200 or 300) and method for synchronous pressurization of ink in a corrugated board sheet feeding system comprises a diaphragm pump assembly including a reciprocating electrically driven crank mechanism connected to and driving first and second diaphragms or diaphragm surfaces, each diaphragm or diaphragm surface housed within a pump housing (e.g., 140, 240 or 340) having an ink inlet and an ink outlet in fluid communication with a manifold configured for pumping liquid ink to printing sections of a corrugated paperboard finishing machine 10 and provide a smooth reciprocating action and more uniform ink flow with reduced pressure pulsations.

### BACKGROUND OF THE INVENTION

This application claims priority to related and commonly owned U.S. provisional patent application No. 62/736,377, filed Sep. 25, 2018 and entitled “Electric Powered Diaphragm Ink Pump Apparatus and Method”, the entire disclosure of which is hereby incorporated herein by reference.

### FIELD OF THE INVENTION

The present invention relates to apparatus and methods for pumping viscous fluids and more particularly for pumping liquid ink to printing sections of paperboard printing machines or paperboard finishing machines.

### DISCUSSION OF THE PRIOR ART

Conventional printing sections utilize anilox and doctor rolls to place a film of ink on a printing plate. Alternatively, doctor blades of various configurations are used in place of a doctor roll in conjunction with the anilox roll and, sometimes, both a doctor roll and a doctor blade are used alternatively in the same printing section. An example of a printing apparatus with a doctor blade is shown in Wells et al U.S. Pat. No. 5,103,732, the disclosure of which is incorporated herein by reference for purposes of describing the technical background and nomenclature used in the art. A diaphragm pump is the type most commonly used to pump ink in the corrugated industry. Such diaphragm pumps are usually powered by compressed air and utilize reciprocally operable resilient diaphragms to suck liquid ink in the bottom of the pump and force it out the top [or vice versa] along with conventional duckbill valves to control the direction of flow. Such diaphragm pumps are available from sources such as Aro Corporation (Aro Center, Bryan, Ohio 43506) and Aro Corp.'s Model 666053-021 is typical.

When paperboard (e.g., corrugated paperboard) finishing machines are being upgraded, the finishing machine operators express concerns about the expense needed to produce large quantities of compressed air to run their ink pumps. The criteria for an ink pump in the corrugated paperboard printing process should include: self-priming, positive displacement, ability to pass bits of scrap, move high-viscosity inks, and be low-maintenance.

Prior art or conventional air-powered double-diaphragm ink pumps provide significant operational benefits and so there is a need for a system which provides the qualities of the air-powered double-diaphragm pump, but which does not require the capitol-intensive air-power system upgrades (with expensive compressor(s) and pneumatic tubing and valving). Other types of air-powered pumps have been used to pump ink in corrugated paperboard printing processes such as the peristaltic pump of Wells et al. U.S. Pat. No. 6,041,709 (the disclosure of which is also incorporated herein by reference for purposes of describing the technical background and nomenclature used in the art) but these prior art references don't overcome the problems associated with expensive upgrades to air-power systems. It should also be noted that pumping viscous ink in significant volumes in commercial corrugated paperboard printing processes is a very different undertaking than, for example, pumping tiny droplets of ink into a printhead in a desktop ink-jet printer.

There is a need, therefore, for a flexible, inexpensive and reliable ink-pumping system and method which provides the qualities of the air-powered double-diaphragm pump (i.e., self-priming, positive displacement, ability to pass bits of scrap while moving high-viscosity inks, and low-maintenance), but which does not require the capitol-intensive air-power system upgrades (with expensive compressor(s) and pneumatic tubing and valving).

### OBJECTS AND SUMMARY OF THE INVENTION

Accordingly, it is an object of the present invention to overcome the above mentioned difficulties by providing an electrically powered, economical, low maintenance double-diaphragm pump for viscous inks and similar fluids.

In accordance with the present invention, an electrically powered, economical, low maintenance double-diaphragm pump (which does not require air-power system upgrades with expensive compressor(s) and pneumatic tubing and valving) provides the qualities of the air-powered double-diaphragm pump (i.e., self-priming, positive displacement, ability to pass bits of scrap while moving high-viscosity inks).

In accordance with the present invention, an electrically powered and electronically controlled diaphragm ink pumping apparatus and method includes an electrically powered diaphragm type pump for ink which replaces traditional air-powered pumps for reduced operational costs. The electrically powered and electronically controlled diaphragm ink pumping apparatus utilizes a reciprocating crank which converts an electric motor's rotary motion into a reciprocating nearly linear motion to move the diaphragms in the pumping chambers. The system and method of the present invention is especially well suited for pumping ink in flexographic printing systems.

The electrically powered and electronically controlled diaphragm ink pump of the present invention retains the traditional benefits of diaphragm pumps and so is ideal for printing on paperboard (e.g., corrugated paperboard in finishing machines) because the pump is positive-displacement, can pass bits of corrugated paper scraps through pump inlets, outlets and valves, and generates enough pumping force to pump viscous inks. Among the advantages of providing an electric-powered pump assembly (e.g., with a brushless DC servo motor) is lower power consumption for the end user or finishing machine operator. In addition, there is no longer a need for the pneumatic plumbing and valves required for air-powered pumps. The cycling action of the crank mechanism in the electrically powered and electronically controlled diaphragm ink pumping apparatus of the present invention is smoother than the intermittent shifting action of the prior art pneumatic or air powered pumps described above, which in turn provides a better ink flow with less surging of the pumped liquid ink.

The electrically powered and electronically controlled diaphragm ink pumping apparatus of the present invention preferably comprises first and second opposed diaphragm heads. These first and second opposed diaphragm heads each have an inlet and outlet and can be used separately or plumbed together with other diaphragm heads for more ink flow volume, as needed for specific applications. An electric motor powers a gear reducer driving at least one output shaft which is connected to turn a crank mechanism that is also connected to one or more horizontally-opposed shafts. The horizontally-opposed shafts, guided by a bearing, push and pull the diaphragm(s) to intake and expel liquid (e.g., ink) from a supply reservoir or head. The cranks are preferably timed or aligned a selected number of (e.g., 180 or 360) degrees apart so that one head is taking liquid in and the other is expelling. The smooth reciprocating action of the crank mechanism reduces pulsations in the liquid flow (as compared to the more abrupt pumping action of air powered pump assemblies). The electrically powered and electronically controlled diaphragm ink pumping apparatus of the present invention preferably also includes duckbill check valves in the heads that control and eliminate backflow allowing the liquid to flow in one direction only. The electrically powered and electronically controlled diaphragm ink pumping apparatus motor's speed is controlled to provide variable speed to allow for fine and reliable adjustment of the flow volume.

The above and still further objects, features and advantages of the present invention will become apparent upon consideration of the following detailed description of a specific embodiment thereof, particularly when taken in conjunction with the accompanying drawings, wherein like reference numerals in the various figures are utilized to designate like components.

### DESCRIPTION OF THE FIGURES

FIG. 1 is a simplified diagrammatic side elevational view of a container blank processing machine of a type having two printing sections with doctor blade heads as might be used in connection with the electrically powered and electronically controlled diaphragm ink pumping apparatus of the present invention.

FIG. 2 is a top view, in elevation of the electrically powered and electronically controlled diaphragm ink pumping apparatus of the present invention.

FIG. 3 is a diaphragm edge view in elevation and partial cross section of the electrically powered and electronically controlled diaphragm ink pumping apparatus of FIG. 2, in accordance with the present invention.

FIG. 4 is a detailed diaphragm edge view in elevation and partial cross section of the electrically powered and electronically controlled diaphragm ink pumping apparatus of FIGS. 2 and 3, with the diaphragm extended, in accordance with the present invention.

FIG. 5 is a diaphragm side view in elevation and partial cross section of the electrically powered and electronically controlled diaphragm ink pumping apparatus of FIGS. 2-4, in accordance with the present invention.

FIG. 6 is a table illustrating ink pumping system performance for the system of the present invention as compared with pneumatically powered systems of the prior art.

FIG. 7 is a perspective view of a dual-diaphragm embodiment of the electrically powered and electronically controlled diaphragm ink pumping apparatus of the present invention.

FIG. 8 is a side view in elevation and partial cross section of the dual-diaphragm embodiment of electrically powered and electronically controlled diaphragm ink pumping apparatus of FIG. 7, in accordance with the present invention.

FIG. 9 is a top view in elevation and partial cross section (taken along the line A-A) of the dual-diaphragm embodiment of electrically powered and electronically controlled diaphragm ink pumping apparatus of FIGS. 7 and 8, in accordance with the present invention.

FIG. 10 is a central section view in elevation and partial cross section (taken along the line B-B) of the dual-diaphragm embodiment of electrically powered and electronically controlled diaphragm ink pumping apparatus of FIGS. 7-9, in accordance with the present invention.

FIG. 11 is an end view (taken along the line C-C) of the dual-diaphragm embodiment of electrically powered and electronically controlled diaphragm ink pumping apparatus of FIGS. 7-9, in accordance with the present invention.

FIG. 12 is a control signal flow diagram illustrating the origins of and paths for control signals to the ink pump motor controller of the present invention.

FIG. 13 is a side view in elevation and partial cross section of a single diaphragm double-acting embodiment of an electrically powered and electronically controlled ink pumping apparatus, in accordance with the present invention.

### DESCRIPTION OF THE PREFERRED EMBODIMENT

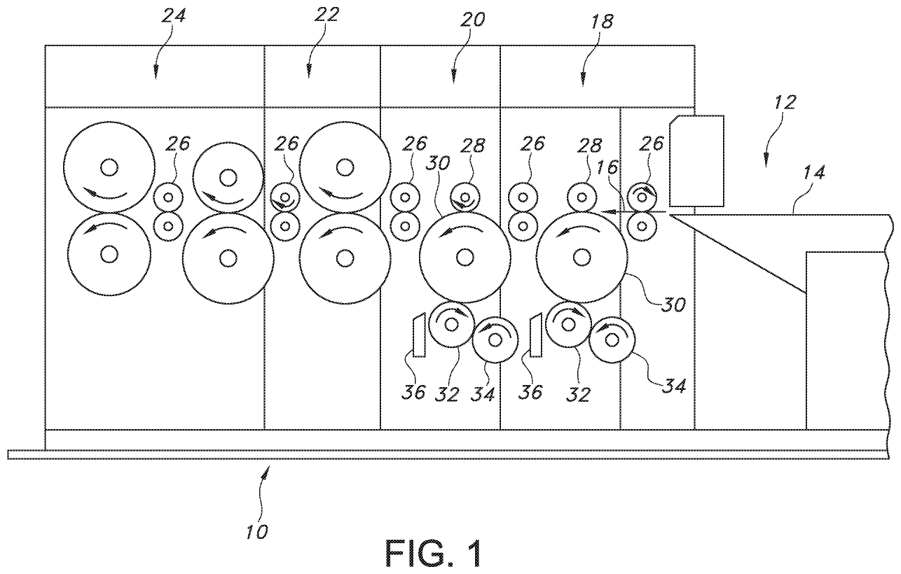

Turning now to FIG. 1, a flexographic printing machine 10 can be fitted with electrically powered and electronically controlled diaphragm ink pumping apparatus 100 of the present invention. Flexographic printing machine 10 (in the illustrated exemplary embodiment) has a feed section 12 for supporting a stack of container blanks (or corrugated paperboard sheets) on a platform 14 and for feeding the blanks one at a time from the bottom of the stack in the downstream direction 16 of the machine. Each blank (in this illustrative example) then passes successively through a first printing section 18, a second printing section 20, a die-cutter section 22, and a yoked creaser and slotter section 24. The various rolls in these sections rotate in the directions indicated by arrows to feed the container blanks through the machine, pairs of feed rolls 26 feeding the blanks from one section to the next. Each printing section 18, 20 has an impression roll 28 cooperating with a print cylinder 30 carrying a printing plate, an anilox roll 32 for inking the printing plate, and a wipe roll 34 and a doctor blade head 36 on opposite sides of the anilox roll 32 for forming an ink fountain with the anilox roll. In printing sections 18, 20, each wipe roll 34 is shown in engagement with its respective anilox roll 32 and each doctor blade head 36 is shown spaced a short distance from the respective anilox roll 32. Thus, each printing section 18, 20 is shown in FIG. 1 with the wipe roll inking system operative and the doctor blade inking system disengaged. Either or both printing sections 18, 20 can be changed to render the wipe roll inking system inoperative and engage the doctor blade inking system. In this illustrative example, dual inking systems, each comprising one wipe roll 34, one doctor blade head assembly 36, and one anilox roll 32, are disposed below the respective print cylinder 30 with the anilox roll 32 between the wipe roll 34 and the doctor blade head 36. In this way, an ink fountain can be established on either side of the anilox roll, this advantageously being either an external fountain with the wipe roll inking system or an internal fountain with the doctor blade head inking system.

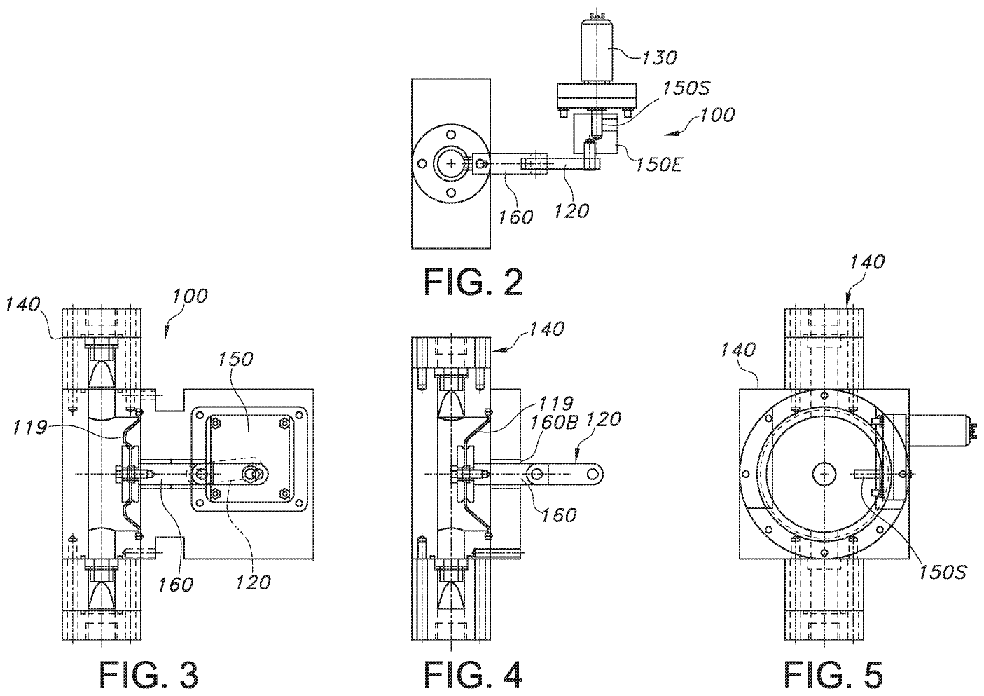

Turning now to FIGS. 2-5, the electrically powered and electronically controlled diaphragm ink pumping apparatus 100 comprises electrically powered, economical, low maintenance double-diaphragm pump assembly that provides the qualities of an air-powered double-diaphragm pump (i.e., self-priming, positive displacement, ability to pass bits of scrap while moving high-viscosity inks). In accordance with the present invention, electrically powered and electronically controlled diaphragm ink pumping apparatus 100 includes an electrically powered diaphragm type pump for ink which replaces traditional air-powered pumps for reduced operational costs when supplying ink to printing system 10. The electrically powered and electronically controlled diaphragm ink pumping apparatus 100 utilizes a reciprocating crank 120 which converts rotary motion from the rotating shaft of electric (e.g., brushless DC servo) motor 130 into a reciprocating nearly or perfectly linear motion (as seen in FIG. 3) to move the diaphragms (e.g., 119) within the pumping chambers of pump housing 140. The system 100 and method of the present invention is especially well suited for economically and reliably pumping ink in flexographic printing systems (e.g., 10, as illustrated in FIG. 1).

Electrically powered and electronically controlled diaphragm ink pump 100 retains the traditional benefits of diaphragm pumps and so is ideal for printing on corrugated paperboard because the pump is positive-displacement, can pass bits of corrugated paper scraps through pump inlets, outlets and valves, and generates enough pumping force to pump viscous inks. Electric-powered pump assembly 100 consumes less power and is less expensive to operate for the end user or finishing machine operator. In addition, there is no longer a need for the pneumatic plumbing and valves required for air-powered pumps. The cycling action of the crank mechanism 120 is smoother than the intermittent shifting action of the prior art pneumatic or air powered pumps described above, which in turn provides a better ink flow with less surging of the pumped liquid ink.

The electrically powered and electronically controlled diaphragm ink pumping apparatus 100 preferably includes first and second opposed diaphragm heads within housing 140 where the first and second opposed diaphragm heads each have an inlet and outlet and can be used separately or plumbed together with other diaphragm heads (not shown) for more ink flow volume, as needed for specific applications.

Electric motor 130 powers a gear reducer 150 (rated to provide, e.g., 50 inch pounds of torque at 25 rpm) driving at least one output shaft 150S which is connected via an eccentric (radially offset) connection member 150E to turn crank mechanism 120 which then transmits reciprocating force via it's connection to one or more horizontally-opposed shaft(s) 160. The horizontally-opposed shaft 160, guided by a bearing 160B, pushes and pulls the pump's diaphragm(s) (e.g., laterally as seen in FIGS. 3 and 4) to draw in and expel liquid (e.g., ink) from a supply reservoir or head (not shown). In multiple diaphragm systems, the cranks are preferably timed or aligned 360 degrees apart so that one head is taking liquid in and the other is expelling. The smooth reciprocating action of the crank mechanism (e.g., 120, 150E and 160) reduces pulsations in the ink's flow (as compared to the more abrupt pumping action of air powered pump assemblies).

The electrically powered and electronically controlled diaphragm ink pumping apparatus 100 preferably also includes duckbill check valves in the heads that control and eliminate backflow allowing the liquid to flow in one direction only. The speed of motor 130 is controlled to provide variable speed to allow for fine and reliable adjustment of the ink-flow volume.

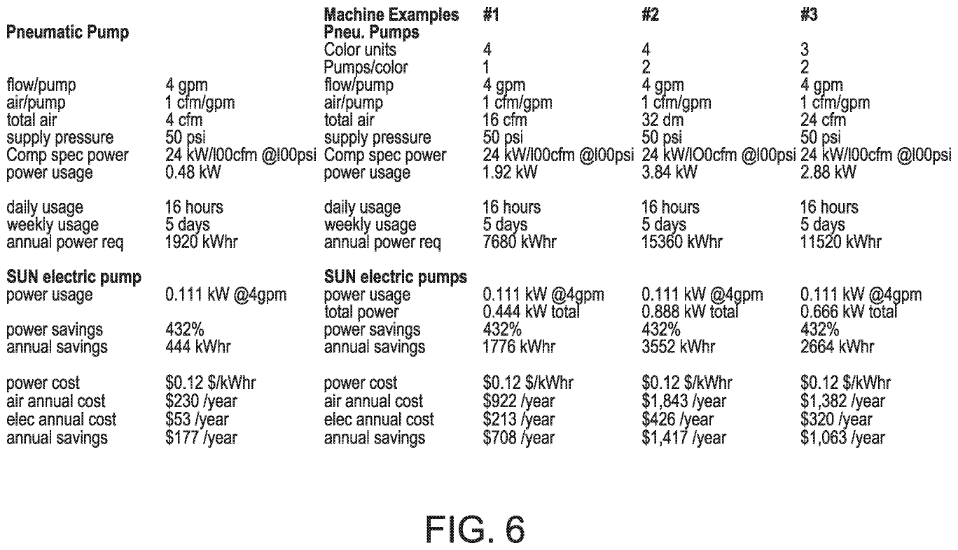

FIG. 6 is a table of information illustrating ink pumping system performance for the electrically powered and electronically controlled diaphragm ink pumping system 100 of the present invention as compared with pneumatically powered systems of the prior art.

It will be appreciated by persons of skill in that art that the present invention makes available a diaphragm pump assembly 100 including a reciprocating electrically driven crank mechanism 120 connected to and driving first and second diaphragms, each of said diaphragms being housed within a pump housing 140 having an ink inlet and an ink outlet in fluid communication with a manifold configured for pumping liquid ink to printing sections of a corrugated paperboard finishing machine. The diaphragm pump assembly's first and second diaphragms are configured as opposing diaphragm heads each being driven by a dedicated crank shaft to push and pull a diaphragm head to intake and expel liquid from each diaphragm head, and the cranks are timed or aligned to operate 360 degrees apart so that when the first diaphragm head is intaking liquid ink, the second diaphragm head is expelling liquid ink. The electrically driven crank mechanism 120 provides a smooth reciprocating action provides a more uniform ink flow with reduced pressure pulsations as compared to the pneumatically driven diaphragm pumps of the prior art.

The electrically powered and electronically controlled diaphragm ink pump apparatus 110 also includes a plurality of check valves in the diaphragm pump assembly pump housing 140 (as best seen in FIGS. 3 and 4) in fluid communication with the ink inlet and ink outlet passages or lumens to eliminate backflow from the manifold configured for pumping liquid ink to printing sections of a corrugated paperboard finishing machine. Preferably the check valves in the diaphragm pump assembly pump housing 140 are configured as “duck bill” style check valves.

The electrically powered and electronically controlled diaphragm ink pump apparatus 100 preferably includes an electric motor 130 configured with an electric motor controller responsive to an ink flow control signal from at least one printing section of the corrugated paperboard finishing machine, wherein the electric motor controller is configured and programmed to vary the speed and position of motor 130 and thereby adjust the flow of ink to at least the one selected printing section of the corrugated paperboard finishing machine.

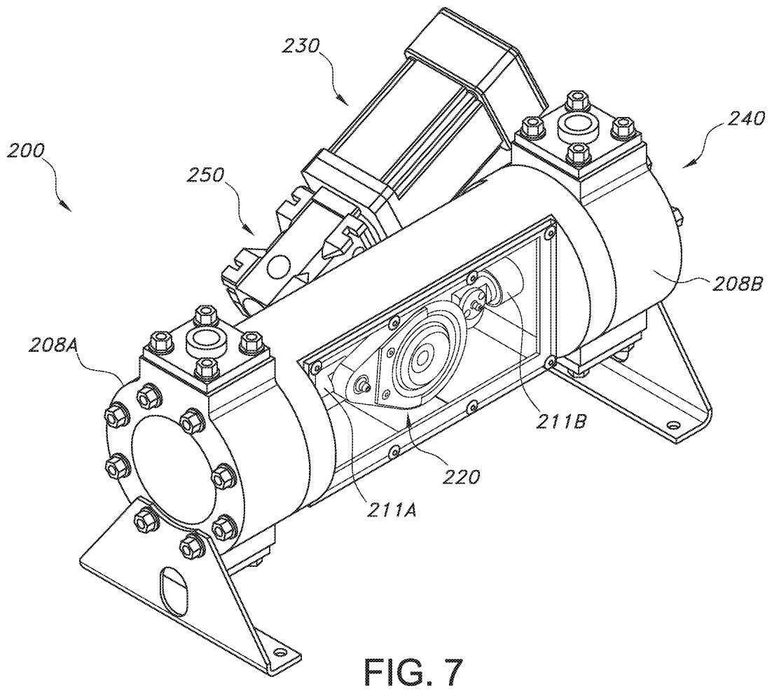

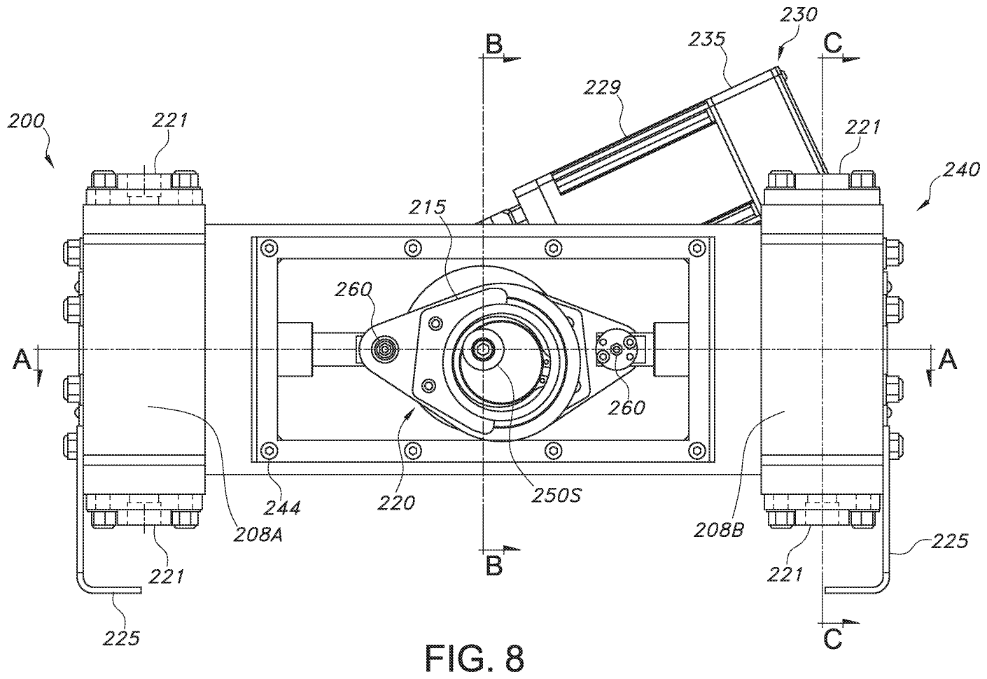

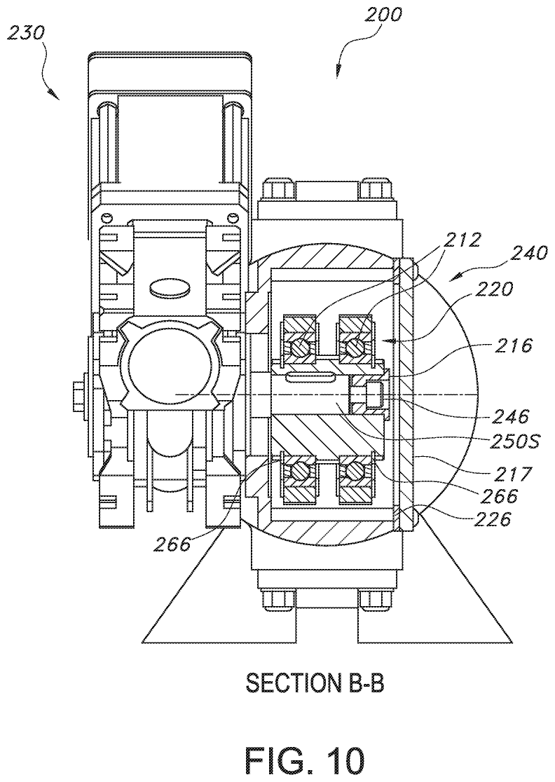

Turning next to FIGS. 7-11, several views of dual-diaphragm embodiment of electrically powered and electronically controlled diaphragm ink pumping apparatus 200 are illustrated. Electronically controlled diaphragm ink pumping apparatus 200 comprises electrically powered, economical, low maintenance double-diaphragm pump assembly that provides many of the qualities of an air-powered double-diaphragm pump (i.e., self-priming, positive displacement, ability to pass bits of scrap while moving high-viscosity inks), but with some surprising improvements. In accordance with the present invention, electrically powered and electronically controlled diaphragm ink pumping apparatus 200 includes an electrically powered diaphragm type pump for ink which replaces traditional air-powered pumps for reduced operational costs when supplying ink to printing system 10.

The electrically powered and electronically controlled diaphragm ink pumping apparatus 200 utilizes a reciprocating crank mechanism 220 which converts rotary motion from the rotating shaft of electric motor 230 into a reciprocating nearly or perfectly linear motion (as seen in FIGS. 7-10) to move the first and second diaphragms 219A, 219B within the first and second head ink pumping chambers 208A, 208B of pump housing 240. The system 200 and method of the present invention is especially well suited for economically and reliably pumping ink in flexographic printing systems (e.g., 10, as illustrated in FIG. 1).

Electrically powered and electronically controlled dual diaphragm ink pump assembly 200 retains many of the traditional benefits of pneumatic diaphragm pumps and so is ideal for printing on corrugated paperboard because the pump is positive-displacement, can pass bits of corrugated paper scraps through pump inlets, outlets and valves, and generates enough pumping force to pump viscous inks. The electric-powered pump assembly 200 confers several advantages, however including being surprisingly more power efficient and much less expensive to operate for the end user or finishing machine operator. In addition, there is no longer a need for the pneumatic plumbing and valves required for air-powered pumps. The cycling action of the crank mechanism 220, in operation, is smoother than the intermittent shifting action of the prior art pneumatic or air powered pumps described above, which in turn provides a better ink flow with less surging of the pumped liquid ink.

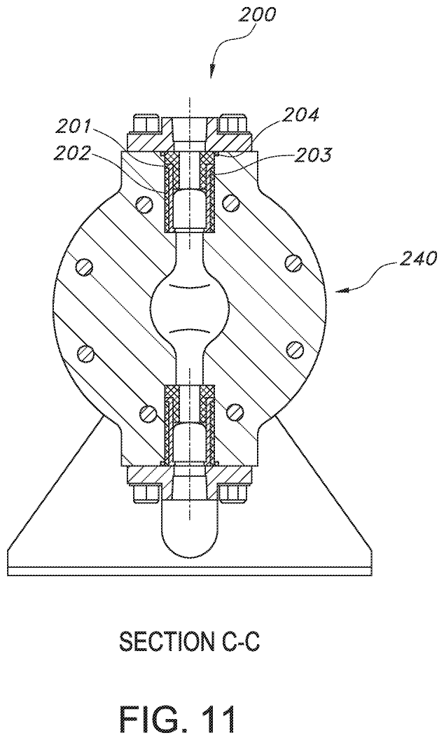

The electrically powered and electronically controlled diaphragm ink pumping apparatus 200 preferably includes first and second opposed diaphragm heads 219A, 219B within housing 240 where the first and second opposed diaphragm heads each have an inlet and outlet (see, e.g., FIG. 11) and can be used separately or plumbed together with other diaphragm heads (not shown) for more ink flow volume, as needed for specific applications.

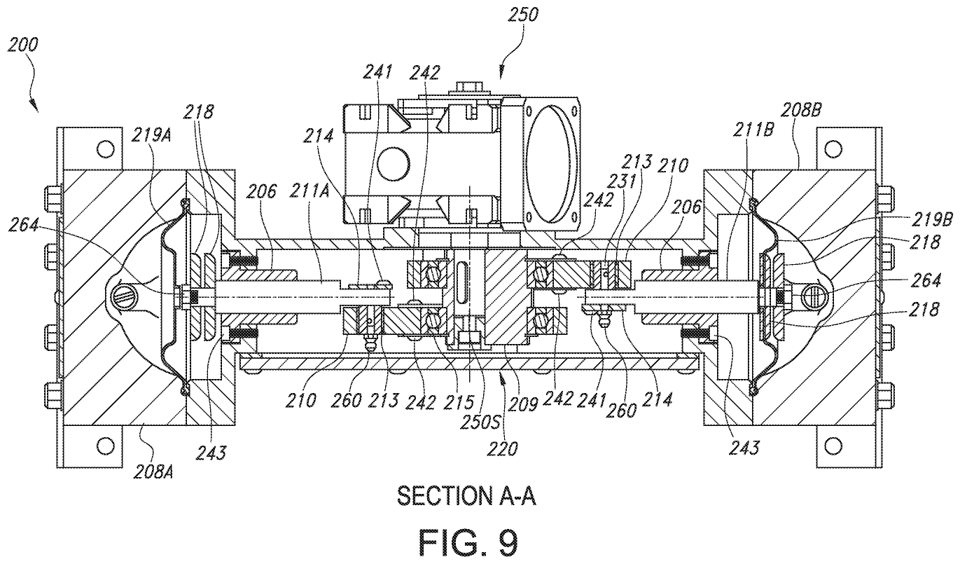

Electric motor 230 powers a gear reducer 250 (e.g., 10 to 1, rated to provide, e.g., 50-170 inch pounds of torque at 25-200 rpm) driving output shaft 250S which is connected via an eccentric (radially offset) connection member 209 to turn crank mechanism 220 which then transmits reciprocating force via it's connection to each of the first and second horizontally-opposed shaft(s) 211A, 211B. Each horizontally-opposed shaft 211A, 211B, is preferably guided by a bearing or bushing 206, and pushes and pulls the pump's diaphragm(s) (e.g., 219A, 219B) laterally, as seen in FIG. 9) to draw in and expel liquid (e.g., ink) from a supply reservoir or head (not shown). In the dual diaphragm system of FIGS. 7-11, the cranks 211A, 211B are preferably timed or aligned (e.g., 180 or 360) degrees apart so the timing or ink pump pressure pulses is optimized for a particular application. In the exemplary embodiment of FIGS. 7-11, cranks 211A, 211B are timed or aligned 180 degrees apart so that one head (e.g., 219A) is taking liquid in and the other (e.g., 219B) is expelling. The smooth reciprocating action of the crank mechanism (e.g., 220) reduces pulsations in the ink's flow (as compared to the more abrupt pumping action of air powered pump assemblies).

The electrically powered and electronically controlled diaphragm ink pumping apparatus 200 preferably also includes duckbill check valve assemblies (e.g., 201, 202, 203 as seen in FIG. 11) in the heads (e.g., 208A, 208B) to control and eliminate backflow allowing the liquid to flow in one direction only. The speed of motor 230 is controlled to provide variable speed to allow for fine and reliable adjustment of the ink-flow volume. As noted above, the motor speed is controlled such that at the output shaft of the gear reducer 250 (which controls crank mechanism 220 and the pump diaphragms) provides 50-170 inch pounds of torque at 25-200 rpm, so for an ink pumping application requiring a pump cycle time of four seconds, the output shaft speed is controlled to approximately 15 RPM, and provides the desired ink flow rate of approximately 100 cc per revolution per diaphragm.

The electrically powered and electronically controlled diaphragm ink pumping apparatus 200 may be configured as illustrated in the exemplary embodiments of FIGS. 7-11 in which duckbill check valve assembly 201 includes sleeve 202 and neoprene insert 204 carried and installed in ink pump body housing 205 with an O-ring 204. Housing 240 is preferably configured as an arrangement of driving and pumping elements aligned along a longitudinal axis with opposing head ink pump sections 208A, 208B each being aligned along that axis with eccentric hub 209, with opposing crank diaphragm pump links 210 and the opposing diaphragm pump shafts 211A, 211B, bearings 212, bushings 213, pin pivot pump cranks 214 and retainer bearing pump cranks 215. The pump body housing 240 preferably includes an inspection window which allows inspection of the internal workings during operation, including the diaphragm pump washers 218. Each pump diaphragm (e.g., 219A, 219B) is preferably configured as a polyurethane membrane of 0.5 mm thickness. The electric motor 230 is preferably a brushless DC servo motor.

It will be appreciated by persons of skill in that art that the present invention makes available a diaphragm pump assembly 200 including a reciprocating electrically driven crank mechanism 220 connected to and driving first and second diaphragms(e.g., 219A, 219B), each of said diaphragms being housed within a pump housing 240 having an ink inlet and an ink outlet in fluid communication with a manifold configured for pumping liquid ink to printing sections of a corrugated paperboard finishing machine. The diaphragm pump assembly's first and second diaphragms (e.g., 219A, 219B) are configured as opposing diaphragm heads each being driven by a dedicated crank shaft 211A, 211B to push and pull a diaphragm head to intake and expel liquid from each diaphragm head, and the cranks are timed or aligned to operate 180 or 360 degrees apart for selected pressure pulse timing. So, for example 180 degrees may be selected so that when the first diaphragm head (e.g., 219A) is intaking liquid ink, the second diaphragm head (e.g., 219B) is expelling liquid ink. The electrically driven crank mechanism 220 provides a smooth reciprocating action provides a more uniform ink flow with reduced pressure pulsations as compared to the pneumatically driven diaphragm pumps of the prior art.

The electrically powered and electronically controlled diaphragm ink pump apparatus 200 also includes a plurality of check valves (e.g., duckbill check valve assemblies 201, 202, 203 as seen in FIG. 11) in the diaphragm pump assembly pump housing 240 (as best seen in FIGS. 7 and 11) in fluid communication with the ink inlet and ink outlet passages or lumens to eliminate backflow from the manifold configured for pumping liquid ink to printing sections of a corrugated paperboard finishing machine. Preferably the check valves in the diaphragm pump assembly pump housing 240 are configured as “duck bill” style check valves.

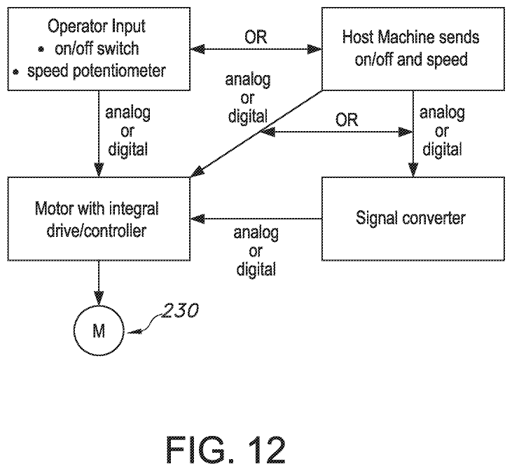

The electrically powered and electronically controlled diaphragm ink pump apparatus 200 preferably includes an electric (e.g., brushless DC servo) motor 230 configured with an electric motor controller (not shown) responsive to an ink flow control signal from at least one printing section of the corrugated paperboard finishing machine (e.g., 10), where (as illustrated in the control signal flow diagram of FIG. 12) the electric motor controller is configured and programmed to accept a signal from pump operator controls or from the host machine's (e.g., 10) controls through a signal conversion device to vary the speed and position of brushless DC servo motor 230 and thereby adjust the flow of ink to at least the one selected printing section of the paperboard (e.g., corrugated paperboard) finishing machine 10.

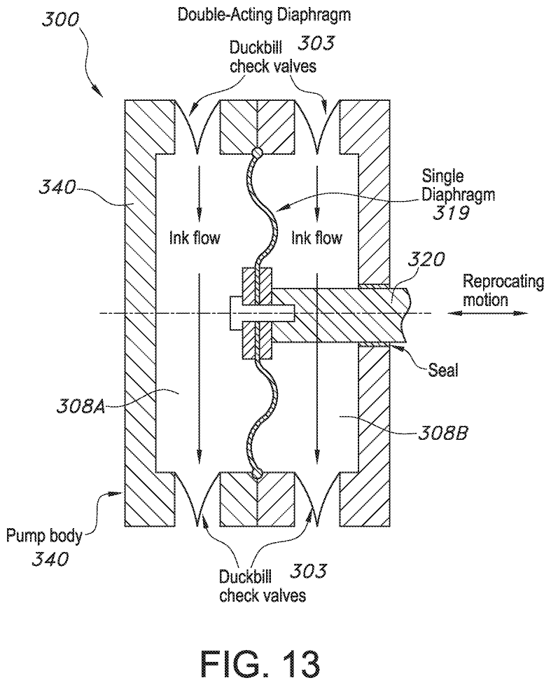

The applicant's most recent development work includes a third alternative configuration illustrated in FIG. 13 which is intended to provide a reciprocating diaphragm pump assembly 300 which is more compact than pump assembly 200 (as illustrated in FIGS. 7-11), the (yet untested) single diaphragm double-acting pump assembly 300 does not require two diaphragms but is currently believed to not sacrifice much flow as compared to the two diaphragm embodiment pump assembly (e.g., 200). Single diaphragm double-acting pump assembly 300 is also an electronically controlled diaphragm ink pumping apparatus comprising electrically powered, economical, low maintenance double-acting signle diaphragm pump assembly that provides many of the qualities of an air-powered double-diaphragm pump (i.e., self-priming, positive displacement, ability to pass bits of scrap while moving high-viscosity inks), but with some surprising improvements.

In accordance with the present invention, electrically powered and electronically controlled diaphragm ink pumping apparatus 300 includes an electrically powered diaphragm type pump for ink which replaces traditional air-powered pumps for reduced operational costs when supplying ink to printing system 10. The electrically powered and electronically controlled diaphragm ink pumping apparatus 300 utilizes a reciprocating crank mechanism 320 which converts rotary motion from the rotating shaft of electric motor (e.g., such as 230) into a reciprocating nearly or perfectly linear motion to move the first and second opposing surfaces of diaphragm 319 within the first and second head ink pumping chambers 308A, 308B of pump housing 340. The orientation of the check valve assemblies 303 controls the direction of ink flow in each of the pumping chambers 308A, 308B and thus the timing of the intake and outflows for each chamber. The system 300 and method of the present invention also believed to be especially well suited for economically and reliably pumping ink in flexographic printing systems (e.g., 10, as illustrated in FIG. 1).

As in the embodiments described above, Double acting diaphragm pump assembly 300 is driven at a controlled speed and for an ink pumping application requiring a pump cycle time of four seconds, the output shaft speed is controlled to approximately 15 RPM, and provides the desired ink flow rate of approximately 100 cc per revolution per diaphragm surface stroke.

In accordance with the method of the present invention, a method for powering and controlling a diaphragm ink pump apparatus (e.g., 100, 200 or 300) in synchronization with a paperboard (e.g., corrugated paperboard) finishing machine sheet feeder (e.g., 10), and the method comprises (a) providing a diaphragm pump assembly (e.g., 100, 200 or 300) including a reciprocating electrically driven crank mechanism connected to and driving a diaphragm assembly (e.g., with first and second diaphragms 219A, 219B) housed within a pump housing having an ink inlet and an ink outlet in fluid communication with a manifold configured for pumping liquid ink to printing sections of a corrugated paperboard finishing machine, wherein said diaphragm pump assembly first and second diaphragms (e.g., 219A, 219B) are configured as opposing diaphragm heads each being driven by a dedicated crank shaft (e.g., 211A, 211B) to push and pull a diaphragm head to intake and expel liquid from the diaphragm head. The method further includes the step of (b) controlling the timing or aligning said crank shafts to operate 180 or 360 degrees apart to select pressure pulse timing and optionally selecting a 180 degree timing so that when said first diaphragm head is intaking liquid ink, said second diaphragm head is expelling liquid ink; wherein said electrically driven crank mechanism provides a smooth reciprocating action provides a more uniform ink flow with reduced pressure pulsations as compared to the pneumatically driven pump prior art.

Having described preferred embodiments of a new and improved ink pumping system and method, it is believed that other modifications, variations and changes will be suggested to those skilled in the art in view of the teachings set forth herein. It is therefore to be understood that all such variations, modifications and changes are believed to fall within the scope of the present invention.

What is claimed is:

1. An electrically powered and electronically controlled diaphragm ink pump apparatus (e.g., 100 or 200) configured to economically and reliably pump viscous ink to printing sections of a paperboard (e.g., corrugated paperboard) finishing machine, comprising:
a diaphragm pump assembly including a reciprocating electrically driven crank mechanism connected to and driving first and second diaphragms, each of said diaphragms being housed within a dedicated first and second pump housing chamber, each of said first and second pump housing chambers having an ink inlet and an ink outlet in fluid communication with a manifold configured for pumping liquid ink to printing sections of a paperboard finishing machine;
said diaphragm pump assembly first and second diaphragms being driven by an electrically driven reciprocating crank mechanism including a crank shaft to push and pull each of said first and second diaphragm heads to intake and expel liquid ink from said first and second first and second pump housing chambers;
wherein said cranks are timed or aligned to operate a selected angle (e.g., 180 or 360 degrees) apart to control timing of ink flow pressure pulses, optionally so that when said first diaphragm head (e.g., 219A) is intaking liquid ink, said second diaphragm head (e.g., 219B) is expelling liquid ink;
wherein said electrically driven crank mechanism provides a smooth reciprocating action provides a more uniform ink flow with reduced pressure pulsations as compared to the pneumatically driven pump prior art.

2. The electrically powered and electronically controlled diaphragm ink pump apparatus of claim 1, further comprising:
a plurality of check valves in said diaphragm pump assembly pump housing in fluid communication with said ink inlet and ink outlet to eliminate backflow from said manifold configured for pumping liquid ink to printing sections of a paperboard finishing machine.

3. The electrically powered and electronically controlled diaphragm ink pump apparatus of claim 1, wherein said check valves in said diaphragm pump assembly pump housing comprise duck bill check valves.

4. The electrically powered and electronically controlled diaphragm ink pump apparatus of claim 1, further comprising:
An electric motor controller responsive to an ink flow control signal from at least one printing section of the corrugated paperboard finishing machine, said electric motor controller being configured and programmed to vary motor speed and adjust the flow of ink to at least said one printing section of the corrugated paperboard finishing machine.

5. The electrically powered and electronically controlled diaphragm ink pump apparatus of claim 1, wherein said motor (e.g., 130 or 230) is a brushless DC servo motor.

6. The electrically powered and electronically controlled diaphragm ink pump apparatus of claim 1, wherein said motor's speed is controlled such that at the output shaft of the gear reducer 250 provides 50-170 inch pounds of torque at 25-200 rpm.

7. The electrically powered and electronically controlled diaphragm ink pump apparatus of claim 6, wherein, for an ink pumping application requiring a pump cycle time of four seconds, the output shaft speed is controlled to approximately 15 RPM, and provides the desired ink flow rate of approximately 100 cc per revolution per diaphragm.

8. An electrically powered and electronically controlled diaphragm ink pump apparatus (e.g., 300) configured to economically and reliably pump viscous ink to printing sections of a paperboard (e.g., corrugated paperboard) finishing machine, comprising:
a diaphragm pump assembly including a reciprocating electrically driven crank mechanism connected to and driving first and second diaphragm surfaces, each of said diaphragm surfaces being housed within and defining a dedicated first and second pump housing chamber (e.g., 308A, 308B), each of said first and second pump housing chambers having an ink inlet and an ink outlet in fluid communication with a manifold configured for pumping liquid ink to printing sections of a paperboard finishing machine;
said diaphragm pump assembly first and second diaphragm surfaces being driven by an electrically driven crank mechanism (e.g., 320) including a crank shaft to push and pull a diaphragm head to intake and expel liquid ink from said first and second first and second pump housing chambers;
wherein said crank reciprocating motion is are timed to control timing of ink flow pressure pulses, optionally so that when said first diaphragm head surface is intaking liquid ink, said second diaphragm head is expelling liquid ink; and wherein said electrically driven crank mechanism provides a smooth reciprocating action provides a more uniform ink flow with reduced pressure pulsations as compared to the pneumatically driven pump prior art.

9. The electrically powered and electronically controlled diaphragm ink pump apparatus of claim 8, further comprising:
a plurality of check valves in said diaphragm pump assembly pump housing 340 in fluid communication with said ink inlet and ink outlet to eliminate backflow from said manifold configured for pumping liquid ink to printing sections of a paperboard finishing machine.

10. The electrically powered and electronically controlled diaphragm ink pump apparatus of claim 8, wherein said check valves in said diaphragm pump assembly pump housing comprise duck bill check valves.

11. The electrically powered and electronically controlled diaphragm ink pump apparatus of claim 8, further comprising:
An electric motor controller responsive to an ink flow control signal from at least one printing section of the corrugated paperboard finishing machine, said electric motor controller being configured and programmed to vary motor speed and adjust the flow of ink to at least said one printing section of the corrugated paperboard finishing machine.

12. The electrically powered and electronically controlled diaphragm ink pump apparatus of claim 8, wherein said motor (e.g., 130 or 230) is a brushless DC servo motor.

13. The electrically powered and electronically controlled diaphragm ink pump apparatus of claim 8, wherein said motor's speed is controlled such that at the output shaft of the gear reducer 250 provides 50-170 inch pounds of torque at 25-200 rpm.

14. The electrically powered and electronically controlled diaphragm ink pump apparatus of claim 8, wherein, for an ink pumping application requiring a pump cycle time of four seconds, the output shaft speed is controlled to approximately 15 RPM, and provides the desired ink flow rate of approximately 100 cc per revolution per diaphragm surface stroke.

15. A method for powering and controlling a diaphragm ink pump apparatus (e.g., 100, 200 or 300) in synchronization with a paperboard (e.g., corrugated paperboard) finishing machine sheet feeder (e.g., 10), comprising:
(a) providing a diaphragm pump assembly (e.g., 100, 200 or 300) including a reciprocating electrically driven crank mechanism connected to and driving first and second diaphragms (e.g., 219A, 219B), each of said diaphragms being housed within a pump housing having an ink inlet and an ink outlet in fluid communication with a manifold configured for pumping liquid ink to printing sections of a corrugated paperboard finishing machine, wherein said diaphragm pump assembly first and second diaphragms (e.g., 219A, 219B) are configured as opposing diaphragm heads each being driven by a dedicated crank shaft 211A, 211B to push and pull a diaphragm head to intake and expel liquid from the diaphragm head;
(b) timing or aligning said crank shafts to operate 180 or 360 degrees apart to select pressure pulse timing and optionally selecting a 180 degree timing so that when said first diaphragm head is intaking liquid ink, said second diaphragm head is expelling liquid ink;
wherein said electrically driven crank mechanism provides a smooth reciprocating action provides a more uniform ink flow with reduced pressure pulsations as compared to the pneumatically driven pump prior art.
